(19) United States
(12) Patent Application Publication
(10) Pub. No.: US 2010/0040873 A1
(43) Pub. Date: Feb. 18, 2010

(54) Two-Layered Copper-Clad Laminate

(75) Inventors: Michiya Kohiki, Ibaraki (JP); Koichi Nakashima, Ibaraki (JP); Naonori Michishita, Ibaraki (JP)

Correspondence Address: HOWSON & HOWSON LLP, 501 OFFICE CENTER DRIVE, SUITE 210, FORT WASHINGTON, PA, 19034, US

(73) Assignee: NIPPON MINING & METALS CO., LTD., Tokyo (JP)

(21) Appl. No.: 12/516,618

(22) PCT Filed: Nov. 14, 2007
(86) PCT No.: PCT/JP2007/072074

§ 371 Date: Jun. 16, 2009

(30) Foreign Application Priority Data
Nov. 29, 2006 (JP) 2006-321174

(51) Int. Cl. B32B 15/088

(52) U.S. Cl. 428/336; 428/458

(57) ABSTRACT

A two-layered copper-clad laminate having a copper layer formed on a polyimide film by sputtering and plating, characterized in that the two-layered copper-clad laminate shows a behavior of shrinkage in MD of the copper-clad laminate and expansion in TD of the copper-clad laminate, and a warpage of the materials for the laminate is 20 mm or less, wherein the warpage represents an extent of lift of the two-layered copper-clad laminate of 100 mm square after maintaining 50% humidity at a temperature of 23° C. for 72 hours. With respect to the two-layered CCL having a copper layer provided on a polyimide film by sputtering and plating, there is provided a two-layered CCL material exhibiting a reduced warpage of the laminate and provides a method for manufacturing the same.

### TECHNICAL FIELD

The present invention generally relates to a two-layered copper-clad laminate in which a copper layer is formed on a polyimide film by sputtering and plating, and particularly to the above-mentioned two-layered copper-clad laminate materials with a reduced warpage.

### BACKGROUND ART

Recently, materials for a two-layered copper-clad laminate (CCL: Cu Clad Laminate) in which a copper layer is formed on a polyimide film have been used as circuit materials for driver IC packaging for liquid crystal displays and the like, for which fine pitch circuits are required. Among the two-layered CCL materials used as laminate materials for COF (Chip On Film), attention is particularly focused on materials for the two-layered CCL manufactured by sputtering and plating.

The two-layered CCL is produced by forming a copper layer with a submicron-level thickness on a polyimide film (PI) by sputtering and then forming a copper layer by copper-sulfate plating. The basic invention is described in Patent Document 1 mentioned below.

However, since the copper layer is formed on the PI layer in the two-layered CCL, the two-layered CCL materials warp due to moisture absorption by the PI layer, internal stress of the copper layer and the like. Warping of the laminate materials may become an obstacle when processing these CCL materials to produce COF, when packaging a driver IC and other elements in the COF, and when mounting the COF with the driver IC and other elements packaged therein in a liquid crystal panel and the like.

Regarding the PI layer in the two-layered CCL materials, there is a conventional technique of preventing the PI layer made of a BPDA-PPD-type polyimide film from curling even if the thickness of the PI layer is reduced (see Patent Document 2).

Also, there is a technique of improving a coefficient of linear expansion and heat dimensional stability and reducing curling when copper foils are placed together, by performing two specific drying steps of drying a thin film formed over the surface of a support using a BPDA-PPD-type polymer solution (see Patent Document 3).

The former technique inhibits curling by selecting an optimum constituent material for the PI layer even when the thickness of the PI layer is reduced. However, the same effect may not always be obtained depending on a copper lamination method. The latter technique controls a rate of the linear expansion coefficient by performing the two drying steps. However, this is for only checking the state of the film from its appearance and it is not clear how much the warpage is actually improved.

In light of the circumstances described above, attempts have been made to optimize the constituent material for the PI layer and to reduce curling by performing the specific two drying steps. These attempts are made to reduce curling by improving the PI layer, however, the object to reduce the warpage of the laminate materials has not been basically achieved with regard to the copper layer, and the above-described solutions are not necessarily satisfactory at present.
[Patent Document 1] U.S. Pat. No. 5,685,970
[Patent Document 2] Japanese Patent Application Laid-Open Publication No. 2006-225667
[Patent Document 3] Japanese Patent Application (Kokoku) Publication No. H4-006213

### DISCLOSURE OF THE INVENTION

The present invention provides, with respect to a two-layered CCL material having a copper layer provided on a polyimide film by sputtering and plating, that a two-layered CCL material exhibiting a reduced warpage of the laminate and provides a method for manufacturing the same.

As a result of thorough examinations to solve the problems described above, the inventors of the present invention found that when manufacturing a two-layered CCL in which a copper layer is formed on a polyimide film by sputtering and plating, if a dimensional change rate in MD (Machine Direction: a film traveling direction when performing roll-to-roll process for a film) is a negative value (shrinkage) and a dimensional change rate in TD (Transversal Direction: a film transverse direction when performing roll-to-roll process for a film) is a positive value (expansion) according to IPC-TM-650, 2.2.4, Methods B and C, a warpage of the laminate materials can be effectively reduced.

The present application provides the following inventions based on the above-described finding:

(1) A two-layered copper-clad laminate having a copper layer formed on a polyimide film by sputtering and plating, characterized in that the two-layered copper-clad laminate shows a behavior of shrinkage in MD of the copper-clad laminate and expansion in TD of the copper-clad laminate, and a warpage of the materials for the laminate is 20 mm or less, wherein the warpage represents an average extent of lift at four corners of the two-layered copper-clad laminate of 100 mm square after maintaining 50% humidity at 23° C. for 72 hours with the copper layer side up.

The warpage of the two-layered copper-clad laminate exceeding 20 mm becomes an obstacle when processing the CCL materials to produce COF, packaging a driver IC and other elements in the COF, and mounting the COF with the driver IC and other elements in liquid crystal panel and the like, as in the case of the conventional techniques. Therefore, the warpage exceeding 20 mm is not favorable.

(2) The two-layered copper-clad laminate according to paragraph (1) above, characterized in that a dimensional change rate of the copper-clad laminate in MD after etching the copper layer in the copper-clad laminate shows the behavior of shrinkage within the range of 0.001% to 0.030%.

The condition that the dimensional change rate of the copper-clad laminate after etching shows shrinkage within the range of 0.001% to 0.030% is effective to reduce the warpage. The copper-clad laminate with a shrinkage rate below or beyond the above-mentioned range has less effect on warping reduction. The copper-clad laminate should preferably exhibit the behavior of shrinkage within the range of 0.003% to 0.023%, which is even more effective for the warping reduction.

(3) The two-layered copper-clad laminate according to paragraph (1), characterized in that a dimensional change rate of the copper-clad laminate in MD after etching the copper layer and applying a heat treatment thereto in the copper-clad laminate shows the behavior of shrinkage within the range of 0.025% to 0.075%.

The condition that the dimensional change rate of the copper-clad laminate after etching and the following heat treatment shows shrinkage within the range of 0.025% to 0.075% is effective for reduction of the warpage. The copper-clad laminate with a shrinkage rate below or beyond the above-mentioned range has a less effect on warping reduction. The copper-clad laminate should preferably exhibit the behavior of shrinkage within the range of 0.025% to 0.045%, which is even more effective for the warping reduction.

The present invention also provides the following inventions:

(4) The two-layered copper-clad laminate according to paragraph (1) or (2), characterized in that a dimensional change rate of the copper-clad laminate in TD after etching the copper layer in the copper-clad laminate shows the behavior of expansion within the range of 0.030% to 0.060%.

The condition that the dimensional change rate of the copper-clad laminate after etching shows expansion within the range of 0.030% to 0.060% is effective for reduction of the warpage in relation to the shrinkage in MD. The copper-clad laminate with an expansion rate below or beyond the above-mentioned range has a less effect on warping reduction. The copper-clad laminate should preferably exhibit the behavior of expansion within the range of 0.040% to 0.050%, which is even more effective for the warping reduction.

(5) The two-layered copper-clad laminate according to any one of paragraphs (1) to (4), characterized in that a dimensional change rate of the copper-clad laminate in TD after etching and following a heat treatment to the copper layer in the copper-clad laminate shows the behavior of expansion within the range of 0.001% to 0.060%.

The condition that the dimensional change rate of the copper-clad laminate after etching and following heat treatment shows expansion within the range of 0.001% to 0.060% is effective for reduction of the warpage in relation to the shrinkage in MD. The copper-clad laminate with an expansion rate below or beyond the above-mentioned range has a less effect on warping reduction. The copper-clad laminate should preferably exhibit the behavior of expansion within the range of 0.035% to 0.055%, which is even more effective for the warping reduction.

Furthermore, the present application provides the following invention:

(6) The two-layered copper-clad laminate according to any one of paragraphs (1) to (5), characterized in that the thickness of the polyimide film is 25 to 50 μm and the thickness of the copper layer is 1 to 20 μm. The two-layered copper-clad laminate having the polyimide film and copper layer with the above-described thicknesses can achieve the object of the present invention.

### EFFECT OF THE INVENTION

A warpage of a two-layered copper-clad laminate according to the present invention is made to become 20 mm or less by making use of behaviors of the two-layered copper-clad laminate shrinking in the MD of the copper-clad laminate and expanding in the TD of the copper-clad laminate. In other words, the warping behaviors of the copper-clad laminate can be buffered and offset and the warpage can be reduced by making the dimensional change rate in the MD become a negative value and the dimensional change rate in the TD become a positive value according to IPC-TM-650, 2.2.4, Methods B and C, that is, by making use of the characteristic of the dimensional change rate values in the MD and TD bearing the opposite signs, positive and negative. As a result, it is possible to obtain the excellent effect of reducing the obstacle when processing CCL materials to produce COF and mounting the COF on a substrate and the like.

### BRIEF DESCRIPTION OF THE DRAWINGS

FIG. 1 is an explanatory diagram showing the result of comparison between a warpage of a two-layered copper-clad laminate product according to the present invention and that of a conventional two-layered copper-clad laminate product;

FIG. 2 shows dimensional change rates of two-layered copper-clad laminates in Example 1 and Comparative Example 1 after etching; and

FIG. 3 shows dimensional change rates of two-layered copper-clad laminates in Example 2 and Comparative Example 2 after etching and following a heat treatment.

### BEST MODE FOR CARRYING OUT THE INVENTION

After a polyimide film is set in a vacuum chamber and the surface of the polyimide film is activated by a plasma treatment, a copper layer in a submicron-level thickness is formed by sputtering. Since the formed copper layer constitutes a seed for forming an electrolytic copper layer later, it is called a “copper seed layer.”

Also, before forming the copper layer in a submicron-level thickness by sputtering, it is possible to form a tie-coat layer made of NiCr on the surface of the polyimide film by sputtering. The plasma treatment on the polyimide film surface and the tie-coat layer are effective means for improving adhesive property. The present invention includes these treatments.

Plating is conducted by, copper sulfate plating and the like. By adjusting the conditions for manufacturing the two-layered copper-clad laminate, such as current density, an electrolyte temperature, and line tension at the time of plating, the copper-clad laminate' behaviors of shrinkage in MD and expansion in TD are exhibited, and by a warpage being 20 mm or less of the two-layered copper-clad laminate in which the copper layer is formed on the polyimide film by sputtering and plating.

Settings of conditions for making the warpage become 20 mm or less vary depending on selection of the polyimide film, selection of the plating conditions such as the current density, electrolyte temperature, and line tension, and the thickness of the copper plating layer. The above-mentioned conditions need to be arbitrarily selected and adjusted. However, it should be understood that the settings of conditions are not limited to specific conditions.

The present invention utilizes the copper-clad laminate's shrinkage in MD and expansion in TD, and this utilization is important to make the warpage of the copper-clad laminate become 20 mm or less and is the requirement for the present invention.

The shrinkage and expansion are adjusted in the manner described below. For example, a sputtered film is applied onto a polyimide film and then a copper plating layer is formed on the polyimide film by forcing the polyimide film to expand in MD. A copper-clad laminate in which copper plating layer expands in MD is formed. Subsequently, the expanded polyimide film is released. As a result, the laminate shrinks in MD. It will be easily understood that the amount of shrinkage can be adjusted by the degree of forced expansion of the polyimide film. As described above, the warpage can be made within the specified range by setting the dimensional change rates in MD and TD stated in claims.

The type of the polyimide film used as the two-layered CCL material of the present invention is not particularly limited as long as it can achieve the present invention; however, a BPDA-PPD type polyimide film may preferably be used. According to this invention, the warpage represents an average extent of lift at four corners of the two-layered copper-clad laminate of 100 mm square after maintaining 50% humidity at 23° C. for 72 hours with the copper layer side up.

The dimensional change rates in MD and TD according to the invention comply with IPC-TM-650, 2.2.4, Methods B and C. Regarding the dimensional change rate serving as an indicator, shrinkage is indicated by a negative value, while expansion is indicated by a positive value.

A difference in dimensional changes between the copper-clad state and the copper-etched state is obtained according to IPC-TM-650, 2.2.4, Method B, while a difference in dimensional changes between the copper-clad state and the state after etching copper and further applying a heat treatment thereto is obtained according to IPC-TM-650, 2.2.4, Method C.
The liquid composition and management conditions of an etchant for the copper layer are as follows:

### (Liquid Composition)

Cupric chloride solution (CuCl₂), Cuprous chloride (CuO)

Hydrochloric acid (HCl): 3.50 mol/L (adjusted within the range of 0 to 6 mol/L)

Hydrogen peroxide (H₂O₂): 30.0 Cap (adjusted within the range of 0 to 99.9 Cap) (The etchant is managed in terms of a specific gravity)

Specific gravity: 1.26 (adjusted within the range of 1.100 to 1.400) (Liquid temperature): 50° C. (adjusted within the range of 45 to 55° C.)
Conditions of the heat treatment are as follows:

Conditions in accordance with IPC-TM-650, 2.2.4, Method C (150° C. ±2° C., 30 minutes ±2 minutes)

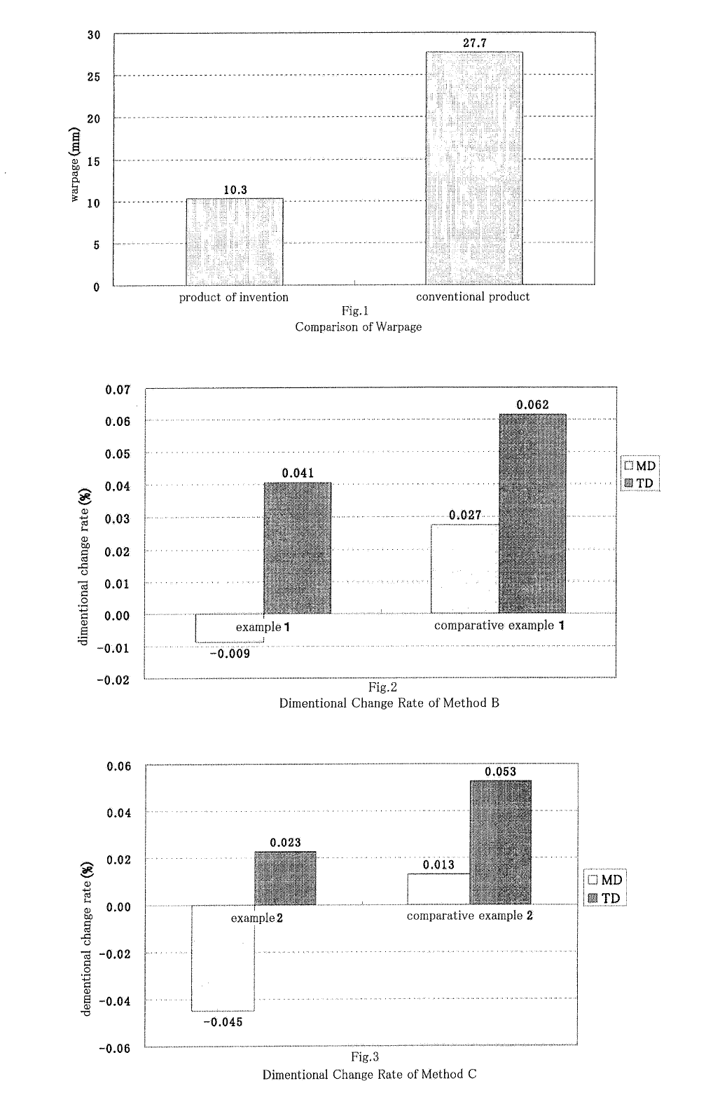

FIG. 1 shows the result of comparison between the warpage of the two-layered copper-clad laminate according to the present invention and the warpage of a conventional two-layered copper-clad laminate. As shown in FIG. 1, the reduced warpage of the two-layered copper-clad laminate according to the present invention is 10.3 mm, which achieves the target value 20 mm of the warpage of the invention. On the other hand, the warpage of the conventional two-layered copper-clad laminate is 27.7 mm. This warpage indicates an extent of lift of a base material of 100 mm square after maintaining 50% humidity at 23° C. for 72 hours. It is apparent that the warpage of the present invention is reduced to approximately one-third, as compared to that of the conventional two-layered copper-clad laminate.

### EXAMPLES

Characteristics of the present invention will be specifically explained below with reference to the attached drawings. Incidentally, the following explanation is given in order to facilitate understanding of the invention, and the invention will not be limited by this explanation. In other words, this invention includes variations, embodiments, and other examples based on the technical ideas of this invention.

### Example 1

A copper layer 8 μm in thickness was formed by sputtering and plating, using a polyimide film (Upilex SGA made by Ube Industries, Ltd.) of 34 μm in thickness. The behavior of the dimensional change rate is one element that can reduce warping.

FIG. 2 shows the dimensional change rate after etching the two-layered copper-clad laminate. Specifically speaking, as a result of measurement of the dimensional change rate in the copper-clad state and in the copper-etched state according to IPC-TM-650, 2.2.4, Method B, the dimensional change rate in MD was −0.009% and the dimensional change rate in TD was 0.041%.

In the case of this invention, the two-layered copper-clad laminate expands in TD and shrinks in MD. It appears that expansion and shrinkage interfere with each other and one offsets the other in the structure of the two-layered copper-clad laminate, which leads to suppression of warping.

### Example 2

FIG. 3 shows the dimensional change rate of the two-layered copper-clad laminate after etching and further applying a heat treatment to the two-layered copper-clad laminate, i.e., the dimensional change rate according to Method C described above. The heat treatment was performed at a temperature of 150° C. ±2° C. for 30 minutes ±2 minutes.

The left side graph in FIG. 3 shows the two-layered copper-clad laminate (product) according to the present invention whose warpage is reduced. FIG. 3 shows the dimensional change rates in MD and TD, respectively. The dimensional change rate in MD was −0.045%, while the dimensional change rate in TD was 0.023%.

In the case of this invention, the two-layered copper-clad laminate expands in TD and shrinks in MD. As explained above, it appears that expansion and shrinkage interfere with each other and one offsets the other in the structure of the two-layered copper-clad laminate, which leads to suppression of warping. The warpage was 10.3 mm. In comparative examples described later (conventional product), the two-layered copper-clad laminate expanded in both MD and TD. It is apparent that this expansion in both directions increases warping.

According to IPC-TM-650, 2.2.4, Methods B and C, when the dimensional change rate in MD was a negative value (shrinkage) and the dimensional change rate in TD was a positive value (expansion), the warpage was 10.3 mm, which was a small value.

### Comparative Example 1

A copper layer 8 μm in thickness was formed by sputtering and plating, using a polyimide film (Upilex SGA made by Ube Industries, Ltd.) of 34 μm in thickness. The right side of FIG. 2 shows a two-layered copper-clad laminate in Comparative Example 1 (conventional product).

As a result of measurement of the dimensional change rate in the copper-clad state and in the copper-etched state according to IPC-TM-650, 2.2.4, Method B, the expansion in MD was 0.027% and that in TD was 0.062% as shown in the right side of FIG. 2.

### Comparative Example 2

Furthermore, as a result of measurement of the dimensional change rate in the copper-clad state and the state after etching and following a heat treatment to copper according to IPC-TM-650, 2.2.4, Method C, the dimensional change rate in MD was 0.013% and the dimensional change rate in TD was 0.053% as shown in the right side of FIG. 3. The warpage was 27.7 mm. The heat treatment was performed at a temperature of 150° C. ±2° C. for 30 minutes ±2 minutes.

Specifically speaking, according to IPC-TM-650, 2.2.4, Methods B and C, when the dimensional change rate in MD was a positive value (expansion) and the dimensional change rate in TD was also a positive value (expansion), the warpage was 27.7 mm, which was a large value.

This value exceeds the target value 20 mm of the warpage according to the present invention, which indicates an unfavorable state. It appears that indication of expansion in the dimensional change rates in both MD and TD will promote warping. According to the comparative examples described above, it is apparent that the present invention has the advantage.

### INDUSTRIAL APPLICABILITY

A warpage of a two-layered copper-clad laminate according to the present invention is made to become 20 mm or less by making use of the behaviors of the two-layered copper-clad laminate shrinking in the MD of the copper-clad laminate and expanding in the TD of the copper-clad laminate. In other words, the warping behaviors of the copper-clad laminate can be buffered and offset and the warpage can be reduced by making the dimensional change rate in the MD become a negative value and the dimensional change rate in the TD become a positive value according to IPC-TM-650, 2.2.4, Methods B and C, that is, by making use of the characteristic of the dimensional change rate values in the MD and TD bearing the opposite signs, positive and negative. As a result, it is possible to obtain the excellent effect of reducing the obstacle when processing CCL materials to produce COF, packaging a driver IC and other elements in the COF, and mounting the COF with the driver IC and other elements in a liquid crystal panel or the like. Therefore, the two-layered copper-clad laminate of this invention is ideal for use as a circuit material for driver IC packaging for such as liquid crystal displays for which fine pitch circuits are required.

1: A two-layered copper-clad laminate having a copper layer formed on a polyimide film by sputtering and plating, characterized in that a dimensional change rate of the copper-clad laminate in MD after etching the copper layer in the copper-clad laminate shows the behavior of shrinkage within the range of 0.001% to 0.030%, a dimensional change rate of the copper-clad laminate in TD after etching the copper layer in the copper-clad laminate shows the behavior of expansion within the range of 0.030% to 0.060% and a warpage of the materials for the laminate is 20 mm or less, wherein the warpage represents an average extent of lift at four corners of the two-layered copper-clad laminate of 100 mm square after maintaining 50% humidity at 23° C. for 72 hours with the copper layer side up.

2. (canceled)

3: The two-layered copper-clad laminate according to claim 1, characterized in that a dimensional change rate of the copper-clad laminate in MD after etching and further applying a heat treatment to the copper layer in the copper-clad laminate shows the behavior of shrinkage within the range of 0.025% to 0.075%, and a dimensional change rate of the copper-clad laminate in TD after etching and further applying a heat treatment to the copper layer in the copper-clad laminate shows the behavior of expansion within the range of 0.001% to 0.060%.

4-5. (canceled)

6: The two-layered copper-clad laminate according to claim 3, characterized in that the thickness of the polyimide film is 25 to 50 μm and the thickness of the copper layer is 1 to 20 μm.

7: The two-layered copper-clad laminate according to claim 1, characterized in that the thickness of the polyimide film is 25 to 50 μm and the thickness of the copper layer is 1 to 20 μm.
